(19) United States
(12) Patent Application Publication
(10) Pub. No.: US 2026/0310936 A1
(43) Pub. Date: Oct. 8, 2026

(54) SYSTEM FOR INTELLIGENTLY DESIGNING FREQUENCY-SELECTIVE METAMATERIAL WITH INTEGRATED ABSORPTION-TRANSMISSION TO ELECTROMAGNETIC WAVES

(71) Applicants: NORTH UNIVERSITY OF CHINA, Taiyuan (CN); SHANXI ZHONGBEI NEW MATERIAL TECHNOLOGY CO., LTD., Taiyuan (CN)

(72) Inventors: Yaqing LIU, Taiyuan (CN); Guanyu HAN, Taiyuan (CN); Guizhe ZHAO, Taiyuan (CN)

(21) Appl. No.: 19/655,655

(22) Filed: Apr. 22, 2026

Related U.S. Application Data
(63) Continuation of application No. PCT/CN2025/105632, filed on Jun. 30, 2025.

(30) Foreign Application Priority Data
Jun. 18, 2025 (CN) 202510818521.6

(51) Int. Cl. G06N 3/045

(52) U.S. Cl. CPC G06N 3/045

(57) ABSTRACT

A system for intelligently design a frequency-selective metamaterial with integrated absorption-transmission to electromagnetic waves, including a first artificial neural network, a second artificial neural network, a third artificial neural network, and a user interface. The first artificial neural network is a S-parameter neural network (SNN), the second artificial neural network is an inverse neural network (INN), and the third artificial neural network is a forward neural network (FNN). The system directly predicts structure parameters of the desired frequency-selective metamaterial according to an input S₂₁ parameter.

### CROSS-REFERENCE TO RELATED APPLICATIONS

This application is a continuation of International Patent Application No. PCT/CN2025/105632, filed on Jun. 30, 2025, which claims the benefit of priority from Chinese Patent Application No. 202510818521.6, filed on Jun. 18, 2025. The content of the aforementioned applications, including any intervening amendments thereto, are incorporated herein by reference.

### TECHNICAL FIELD

This application relates to electromagnetic metamaterials, and more particularly to a system for intelligently designing a frequency-selective metamaterial with integrated absorption-transmission to electromagnetic waves.

### BACKGROUND

With the rapid development of science and technology, information warfare has gradually become a core of military conflicts in a new era. Radar, as the most mature and widely used detection method, plays a vital role in modern warfare. The radar has capabilities of monitoring, tracking, and precisely locating air, sea, and ground targets, making it one of the primary threats faced by multi-dimensional weapon platforms, therefore, evading enemy radar detection has become a key of battlefield success. Meanwhile, these platforms are equipped with advanced radar systems for detecting and striking targets, but heir high-power electromagnetic radiation also makes them vulnerable to enemy radar countermeasures and attacks.

To address this contradiction, a stealth design for radar systems has become a research hotspot. Stealth radomes become an ideal solution due to their advantages of requiring no major modifications to the radar, low cost, and high efficiency. However, traditional wave-absorbing materials and stealth structures struggle to balance electromagnetic transmission in the radar’s operating frequency band with stealth in other bands. In recent years, metamaterial technology has provided new approaches to solving this challenge. Frequency-selective metamaterial with integrated absorption-transmission to electromagnetic waves as a dual-mode metamaterial, not only enable electromagnetic wave transmission in the radar’s operating band but also absorb electromagnetic waves in other bands, significantly reducing echo reflections from multiple directions and enhancing the platform's overall stealth performance. However, due to the dual-mode characteristics and in combination with traditional and emerging artificial electromagnetic structures, such as frequency-selective metamaterials, circuit analog absorbers, and Salisbury screen absorbers, the frequency-selective metamaterial with integrated absorption-transmission to electromagnetic waves has considerable complexity. Therefore, electromagnetic simulation and optimization methods in traditional metamaterial design struggle to flexibly adjust their performance in a short time, failing to meet diverse performance requirements of radomes for different radar systems.

In recent years, artificial intelligence has rapidly emerged as a highly anticipated cutting-edge interdisciplinary technology, driven by advancements in computer hardware and internet infrastructure, and has been widely applied across industries such as manufacturing, healthcare, transportation, and even military fields. Artificial neural networks, by simulating operational principles of biological brains, can generate inferential responses to complex problems in an extremely short time based on existing data after scientific and reasonable training and learning, presenting a novel pathway for achieving rapid, real-time, and customized design of the frequency-selective metamaterial with integrated absorption-transmission to electromagnetic waves.

### SUMMARY

In order to solve the problem that traditional design methods for metamaterial are difficult to flexibly adjust the structure and performance of frequency-selective metamaterial with integrated absorption-transmission to electromagnetic waves, this application provides a system for intelligently designing a frequency-selective metamaterial with integrated absorption-transmission to electromagnetic waves.

Technical solutions of the present disclosure are described as follows.

The present disclosure provides the system for intelligently designing the frequency-selective metamaterial with integrated absorption-transmission to electromagnetic waves, comprising:
a first artificial neural network;
a second artificial neural network;
a third artificial neural network;
and a user interface;
wherein the first artificial neural network is a S-parameter neural network (SNN);
the second artificial neural network is an inverse neural network (INN); and
the third artificial neural network is a forward neural network (FNN); and
the SNN is a fully connected neural network, comprising a first input layer, a first hidden layer, and a first output layer;
the number of nodes in the first input layer Input(S) is 101-1601;
the number of sub-layers of the first hidden layer Hide(S-D) is 1-10;
the number of nodes in each sub-layer of the first hidden layer Hide(S-W) is 100-600;
the number of nodes in the first output layer Output(S) is 101-1601; and
the SNN is configured to input a target electromagnetic response parameter S₂₁ of a desired metamaterial, and predict and output a target electromagnetic response parameter S₁₁of the desired metamaterial; the INN is a fully connected neural network comprising an S₁₁ input sub-network, an S₂₁ input sub-network, and a structure parameter prediction sub-network;
the S₁₁ input sub-network comprises a second input layer, a second hidden layer, and a second output layer; the number of nodes in the second input layer Input(I-S₁₁) is 101-1601; the number of sub-layers of the second hidden layer Hide(I-S₁₁-D) is 1-5;
the number of nodes in each sub-layer of the second hidden layer Hide(I-S₁₁-W) is 100-300; the number of nodes in the second output layer Output(I-S₁₁) is 101-1601; and
the S₁₁ input sub-network is configured to process the target electromagnetic response parameter S₁₁;
the S₂₁ input sub-network comprises a third input layer, a third hidden layer, and a third output layer; the number of nodes in the third input layer Input(I-S₂₁) is 101-1601;
the number of sub-layers of the third hidden layer Hide(I-S₂₁-D) is 1-5; the number of nodes in each sub-layer of the third hidden layer Hide(I-S₂₁-W) is 100-300; the number of nodes in the third output layer Output(I-S₂₁) is 101-1601; and the S₂₁ input sub-network is configured to process the target electromagnetic response parameter S₂₁; and
the structure parameter prediction sub-network comprises a fourth input layer, a fourth hidden layer, and a fourth output layer; the number of nodes in the fourth input layer Input(I-P) is calculated by Input(I-P)=Output(I-S₁₁)+Output(I-S₂₁);
the number of sub-layers of the fourth hidden layer Hide(I-P-D) is 1-5; the number of nodes in each sub-layer of the fourth hidden layer Hide(I-P-W) is 100-300;
the number of nodes in the fourth output layer Output(I-P) is 5; and the structure parameter prediction sub-network is configured to predict a structure parameter conform to the target electromagnetic response parameter S₁₁ and the target electromagnetic response parameter S₂₁based on data from the S₁₁input sub-network and the S₂₁ input sub-network;
the FNN is a fully connected neural network comprising a structure parameter input sub-network, an S₁₁ prediction sub-network, and an S₂₁ prediction sub-network; the structure parameter input sub-network comprises a fifth input layer, a fifth hidden layer, and a fifth output layer;
the number of nodes in the fifth input layer Input(F-P) is 5;
the number of sub-layers of the fifth hidden layer Hide(F-P-D) is 1-5;
the number of nodes in each sub-layer of the fifth hidden layer Hide(F-P-W) is 100-400;
the number of nodes in the fifth output layer Output(F-P) is 100-400; and
the structure parameter input sub-network is configured to process the structure paramete predicted by the structure parameter prediction sub-network;
the S₁₁ prediction sub-network comprises a sixth input layer, a sixth hidden layer, and a sixth output layer;
the number of nodes in the sixth input layer Input(F-S₁₁) is 50-350;
the number of sub-layers of the sixth hidden layer Hide(F-S₁₁-D) is 1-5;
the number of nodes in each sub-layer of the sixth hidden layer Hide(F-S₁₁-W) is 100-300;
the number of nodes in the sixth output layer Output(F-S₁₁) is 101-1601; and
the S₁₁ prediction sub-network is configured to predict an S₁₁ parameter conform to a structure parameter based on data from the structure parameter input sub-network;
the S₂₁ prediction sub-network comprises a seventh input layer, a seventh hidden layer, and a seventh output layer;
the number of nodes in the seventh input layer Input(F-S₂₁) is calculated by Input(F-S₂₁)=Output(F-P)-Input(F-S₁₁);
the number of sub-layers of the seventh hidden layer Hide(F-S₂₁-D) is 1-5;
the number of nodes in each sub-layer of the seventh hidden layer Hide(F-S₂₁-W) is 100-300;
the number of nodes in the seventh output layer Output(F-S₂₁) is 101-1601; and
the S₂₁ prediction sub-network is configured to predict an S₂₁ parameter conform to the structure parameter based on data from the structure parameter input sub-network; and
the user interface comprises 9 freely-draggable User-Points, an S₂₁ input curve generated by interpolation of the 9 freely-draggable User-Points, a structure parameter design result predicted by the INN, and a real-time adjustable and interactive graphical interface formed by an S₁₁ parameter curve and an S₂₁ parameter curve reconstructed by the FNN, a first reference line fixed at -3 dB and a second reference line fixed at -10 dB.

In an embodiment, the desired metamaterial has a symmetric structure composed of n × n unit structures arranged periodically, and n is a positive integer; each of the n × n unit structures comprises a first frequency-selective metastructure layer, a dielectric layer and a second frequency-selective metastructure layer laminated in sequence from bottom to top; and the second frequency-selective metastructure layer is a lossy frequency-selective metastructure layer; and

one unit structure of the first frequency-selective metastructure layer has a square-ring shape, having an outer-ring side length a₁ of 15.15-23.71 mm, an inner-ring side length a₂ of 9.04-14.33 mm, and a sheet resistance of 3-5 Ω/sq; one unit structure of the dielectric layer is square, and has a side length of a₁and a thickness h of 3.12-9.16 mm; and one unit structure of the second frequency-selective metastructur layer has a cross shape, and has a unit size of a₁, an arm length b₁of 14.72-20.75 mm, an arm width b₂of 1.23-3.25 mm, and a sheet resistance of 4-25 Ω/sq.

Compared to the prior art, the present disclosure has the following beneficial effects.
(1) Based on the system for intelligently designing the frequency-selective metamaterial comprising multiple neural networks, the present disclosure directly predicts the structure parameters of the frequency-selective metamaterial with integrated absorption-transmission to electromagnetic waves according to the S₂₁ parameter. Compared to the prior art, the present disclosure completes a design of a structure of the frequency-selective metamaterial with integrated absorption-transmission to electromagnetic waves in a short time, greatly improving design efficiency, and can realize real-time structure design according to target performance requirements.
(2) Simplified graphical user interface of the present disclosure allows designers to input desired target performances by directly dragging points on an image, while verifying actual design results through real-time displayed S₁₁parameter curve and S₂₁parameter curve, which simplifies design process, and lowers a design threshold for design of the frequency-selective metamaterial with integrated absorption-transmission to electromagnetic waves

### BRIEF DESCRIPTION OF THE DRAWINGS

The accompanying drawings herein form a part of the specification to show conforming embodiment and illustrate the disclosure together with the embodiments.

In order to illustrate the technical solutions in the embodiments of the present disclosure or the prior art more clearly, the needed accompanying drawings will be briefly described below. It is obviously that for those of ordinary skill in the art, other accompanying drawings can be obtained from the structures illustrated therein without making creative effort. system for intelligently designing a frequency-selective metamaterial

FIG. 1 shows an overall structure of a system for intelligently designing a frequency-selective metamaterial with integrated absorption-transmission to electromagnetic waves according to an embodiment of the present disclosure.

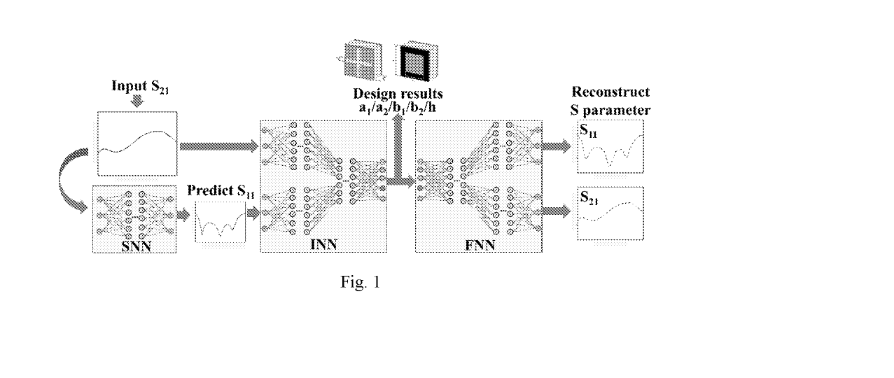

FIG. 2 is a structural diagram of a S-parameter neural network (SNN) of the system according to an embodiment of the present disclosure.

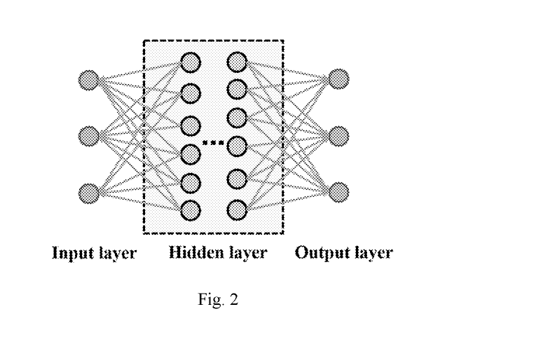

FIG. 3 is a structural diagram of an inverse neural network (INN) of the system according to an embodiment of the present disclosure.

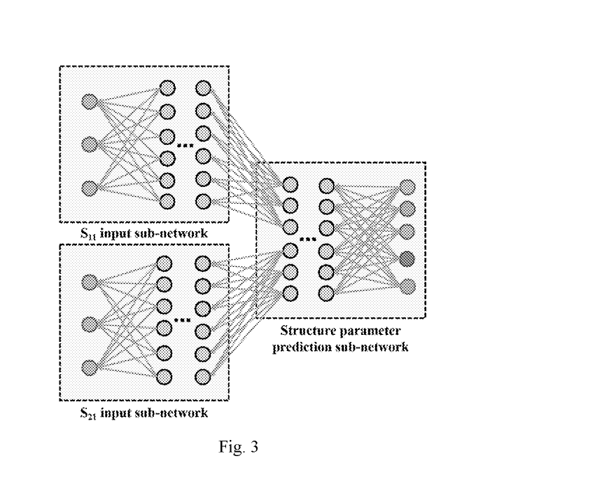

FIG. 4 is a structural diagram of a forward neural network (FNN) of the system according to an embodiment of the present disclosure.

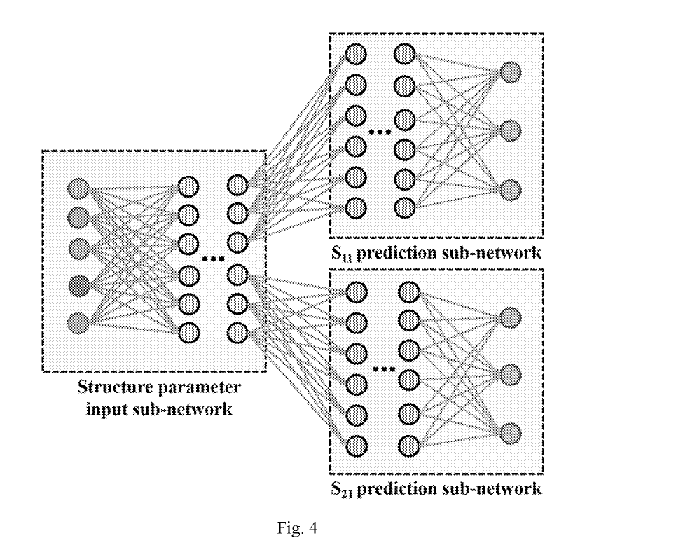

FIG. 5 shows a user interface of the system according to an embodiment of the present disclosure.

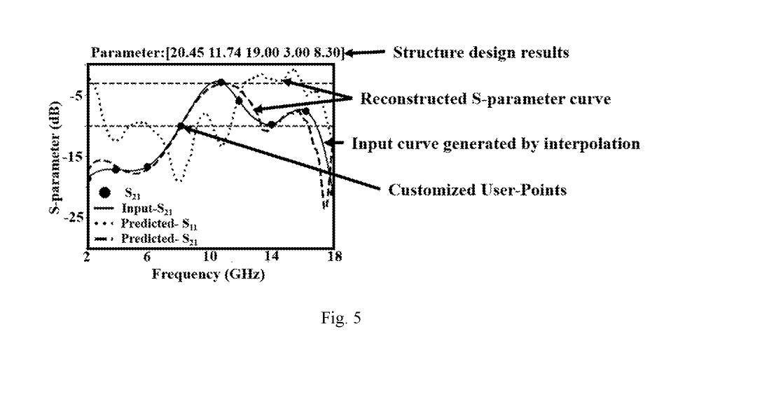

FIG. 6 shows a unit structure of each of n × n units of the frequency-selective metamaterial with integrated absorption-transmission to electromagnetic waves according to an embodiment of the present disclosure.

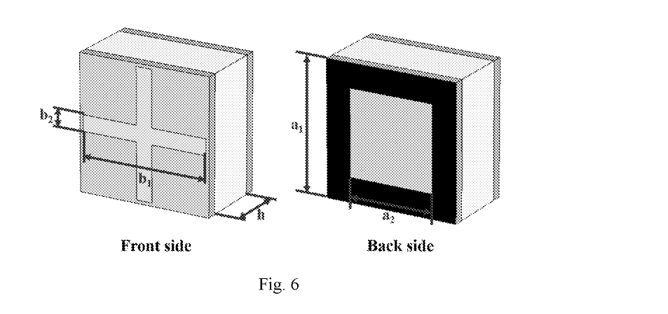

FIG. 7 is a front view of the frequency-selective metamaterial according to an embodiment of the present disclosure.

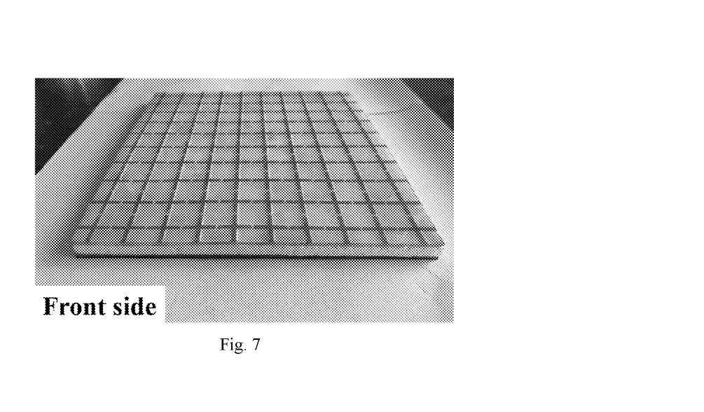

FIG. 8 is a back view of the frequency-selective metamaterial according to an embodiment of the present disclosure.

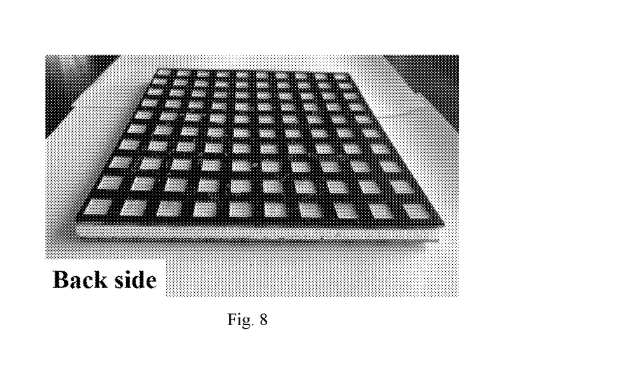

FIG. 9a is an image of a design result of Embodiment 1 shown on the user interface of the present disclosure.

FIG. 9b is an image of a design result of Embodiment 2 shown on the user interface of the present disclosure.

FIG. 9c is an image of a design result of Embodiment 3 shown on the user interface of the present disclosure.

FIG. 9d is an image of a design result of Embodiment 4 shown on the user interface of the present disclosure.

### DETAILED DESCRIPTION OF EMBODIMENTS

In order to make the above object, features and advantages of the present disclosure more clearly, the present disclosure will be further described below. It should be noted that embodiments and features of the embodiments of the present disclosure can be combined without conflicts.

Details described below are for illustrating the present disclosure, and the present disclosure can be implemented through methods different from description herein. It is obviously that embodiments in this specification are only part of the embodiment, rather than all the embodiments.

Specific embodiments of the present disclosure are described below in detail.

### Embodiment 1

A system for intelligently designing a frequency-selective metamaterial with integrated absorption-transmission to electromagnetic waves includes a first artificial neural network, a second artificial neural network, a third artificial neural network, and

a user interface. The first artificial neural network is a S-parameter neural network (SNN). The second artificial neural network is an inverse neural network (INN). The third artificial neural network is a forward neural network (FNN).

The SNN is a fully connected neural network, including a first input layer, a first hidden layer, and a first output layer. The number of nodes in the first input layer Input(S) is 101. The number of sub-layers of the first hidden layer Hide(S-D) is 1. The number of nodes in each sub-layer of the first hidden layer Hide(S-W) is 600. The number of nodes in the first output layer Output(S) is 101.

The INN is a fully connected neural network including an S₁₁ input sub-network, an S₂₁ input sub-network, and a structure parameter prediction sub-network.
(1) The S₁₁ input sub-network includes a second input layer, a second hidden layer, and a second output layer. The number of nodes in the second input layer Input(I-S₁₁) is 101. The number of sub-layers of the second hidden layer Hide(I-S₁₁-D) is 5. The number of nodes in each sub-layer of the second hidden layer Hide(I-S₁₁-W) is 100. The number of nodes in the second output layer Output(I-S₁₁) is 101.
(2) The S₂₁ input sub-network includes a third input layer, a third hidden layer, and a third output layer. The number of nodes in the third input layer Input(I-S₂₁) is 101. The number of sub-layers of the third hidden layer Hide(I-S₂₁-D) is 5. The number of nodes in each sub-layer of the third hidden layer Hide(I-S₂₁-W) is 100. The number of nodes in the third output layer Output(I-S₂₁) is 101.
(3) The structure parameter prediction sub-network includes a fourth input layer, a fourth hidden layer, and a fourth output layer. The number of nodes in the fourth input layer Input(I-P) is 202. The number of sub-layers of the fourth hidden layer Hide(I-P-D) is 5. The number of nodes in each sub-layer of the fourth hidden layer Hide(I-P-W) is 100. The number of nodes in the fourth output layer Output(I-P) is 5.

The FNN is a fully connected neural network including a structure parameter input sub-network, an S₁₁ prediction sub-network, and an S₂₁ prediction sub-network.
(1) The structure parameter input sub-network includes a fifth input layer, a fifth hidden layer, and a fifth output layer. The number of nodes in the fifth input layer Input(F-P) is 5. The number of sub-layers of the fifth hidden layer Hide(F-P-D) is 1. The number of nodes in each sub-layer of the fifth hidden layer Hide(F-P-W) is 400. The number of nodes in the fifth output layer Output(F-P) is 400.
(2) The S₁₁ prediction sub-network includes a sixth input layer, a sixth hidden layer, and a sixth output layer. The number of nodes in the sixth input layer Input(F-S₁₁) is 50. The number of sub-layers of the sixth hidden layer Hide(F-S₁₁-D) is 1. The number of nodes in each sub-layer of the sixth hidden layer Hide(F-S₁₁-W) is 300. The number of nodes in the sixth output layer Output(F-S₁₁) is 101.
(3) The S₂₁ prediction sub-network includes a seventh input layer, a seventh hidden layer, and a seventh output layer. The number of nodes in the seventh input layer Input(F-S₂₁) is 350. The number of sub-layers of the seventh hidden layer Hide(F-S₂₁-D) is 1. The number of nodes in each sub-layer of the seventh hidden layer Hide(F-S₂₁-W) is 300. The number of nodes in the seventh output layer Output(F-S₂₁) is 101.

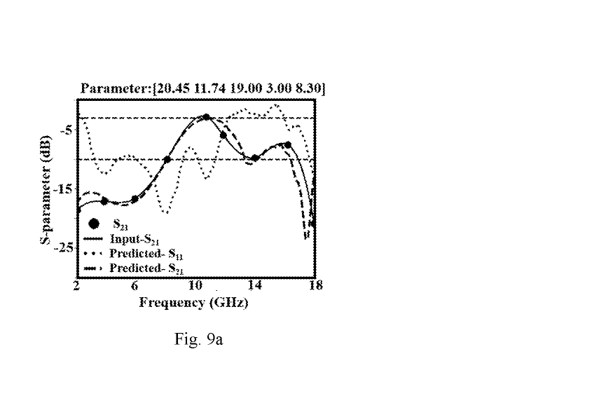

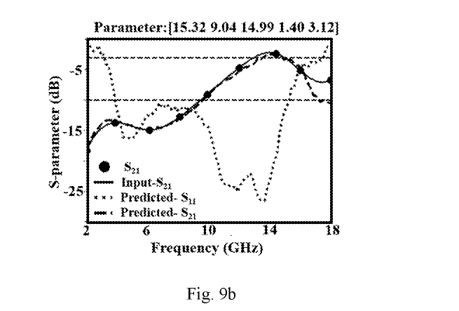

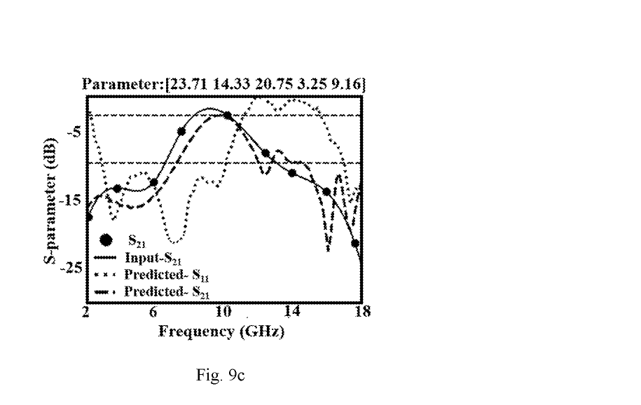

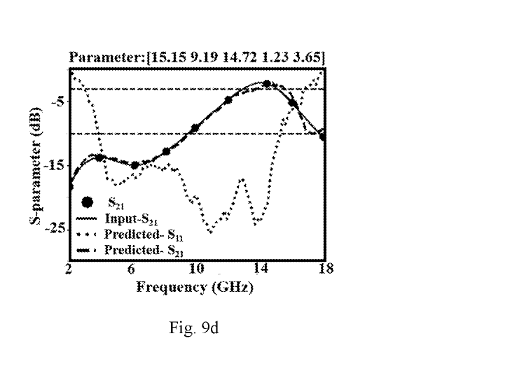

Referring to the user interface shown in FIG. 9a, a designed frequency-selective metamaterial with integrated absorption-transmission to electromagnetic waves has a symmetric structure composed of n × n unit structures arranged periodically. Each of the n × n unit structures includes a first frequency-selective metastructure layer, a dielectric layer and a second frequency-selective metastructure layer laminated in sequence from bottom to top. One unit structure of the first frequency-selective metastructure layer has a square-ring shape, having an outer-ring side length a₁of 20.45 mm, an inner-ring side length a₂ of 11.74 mm, and a sheet resistance of 5 Ω/sq. One unit structure of the second frequency-selective metastructure layer has a cross shape, and has a unit size of a₁, an arm length b₁of 19 mm, an arm width b₂of 3.00 mm, and a sheet resistance of 20 Ω/sq. One unit structure of the dielectric layer has a square shape, and has a side length of a₁ and a thickness h of 8.30 mm. The designed frequency-selective metamaterial realizes an absorption bandwidth (S₁₁≤–10 dB and S₂₁≤–10 dB) within 2.98-4.55 GHz, 6.15-8.00 GHz, and 16.72-18 GHz and a transmission bandwidth (S₁₁≤-10 dB and S₂₁≥-3 dB) within 10.06-11.41 GHz.

### Embodiment 2

A system for intelligently designing a frequency-selective metamaterial with integrated absorption-transmission to electromagnetic waves of this embodiment is the same as that of Embodiment 1, except parameters as follows.

The number of nodes in the first input layer Input(S) is 1601, the number of sub-layers of the first hidden layer Hide(S-D) is 10, the number of nodes in each sub-layer of the first hidden layer Hide(S-W) is 100, and the number of nodes in the first output layer Output(S) is 1601.

The INN is the fully connected neural network including the S₁₁ input sub-network, the S₂₁ input sub-network, and the structure parameter prediction sub-network.
(1) The S₁₁ input sub-network includes the second input layer, the second hidden layer, and the second output layer. The number of nodes in the second input layer Input(I-S₁₁) is 1601. The number of sub-layers of the second hidden layer Hide(I-S₁₁-D) is 1. The number of nodes in each sub-layer of the second hidden layer Hide(I-S₁₁-W) is 300. The number of nodes in the second output layer Output(I-S₁₁) is 1601.
(2) The S₂₁ input sub-network includes the third input layer, the third hidden layer, and the third output layer. The number of nodes in the third input layer Input(I-S₂₁) is 1601. The number of sub-layers of the third hidden layer Hide(I-S₂₁-D) is 1. The number of nodes in each sub-layer of the third hidden layer Hide(I-S₂₁-W) is 300. The number of nodes in the third output layer Output(I-S₂₁) is 1601.
(3) The structure parameter prediction sub-network includes the fourth input layer, the fourth hidden layer, and the fourth output layer. The number of nodes in the fourth input layer Input(I-P) is 3202. The number of sub-layers of the fourth hidden layer Hide(I-P-D) is 1. The number of nodes in each sub-layer of the fourth hidden layer Hide(I-P-W) is 300. The number of nodes in the fourth output layer Output(I-P) is 5.

Referring to the user interface shown in FIG. 9b, a designed frequency-selective metamaterial with integrated absorption-transmission to electromagnetic waves has the symmetric structure composed of n × n unit structures arranged periodically. Each of the n × n unit structures includes the first frequency-selective metastructure layer, the dielectric layer and the second frequency-selective metastructure layer laminated in sequence from bottom to top. One unit structure of the first frequency-selective metastructure layer has a square-ring shape, having an outer-ring side length a₁ of 15.32 mm, an inner-ring side length a₂ of 9.04 mm, and a sheet resistance of 4 Ω/sq. One unit structure of the second frequency-selective metastructure layer has a cross shape, and has a unit size of a₁_{,} an arm length b₁of 14.99 mm, an arm width b₂of 1.40 mm, and a sheet resistance of 25 Ω/sq. One unit structure of the dielectric layer has a square shape, and has a side length of a₁ and a thickness h of 3.12 mm. The designed frequency-selective metamaterial realizes an absorption bandwidth (S₁₁≤–10 dB and S₂₁≤–10 dB) within 4.09-10.04 GHz and a transmission bandwidth (S₁₁≤-10 dB and S₂₁≥-3 dB) within 12.80-15.00 GHz.

### Embodiment 3

A system for intelligently designing a frequency-selective metamaterial with integrated absorption-transmission to electromagnetic waves of this embodiment is the same as that of Embodiment 1, except that another frequency-selective metamaterial is designed through the user interface.

Referring to the user interface shown in FIG. 9c, a designed frequency-selective metamaterial with integrated absorption-transmission to electromagnetic waves has the symmetric structure composed of n × n unit structures arranged periodically. Each of the n × n unit structures includes the first frequency-selective metastructure layer, the dielectric layer and the second frequency-selective metastructure layer laminated in sequence from bottom to top. One unit structure of the first frequency-selective metastructure layer has a square-ring shape, having an outer-ring side length a₁ of 23.71 mm, an inner-ring side length a₂ of 14.33 mm, and a sheet resistance of 5 Ω/sq. One unit structure of the second frequency-selective metastructure layer has a cross shape, and has a unit size of a₁_{,} an arm length b₁of 20.75 mm, an arm width b₂of 3.25 mm, and a sheet resistance of 25 Ω/sq. One unit structure of the dielectric layer has a square shape, and has a side length of a₁ and a thickness h of 9.16 mm. The designed frequency-selective metamaterial realizes an absorption bandwidth (S₁₁≤–10 dB and S₂₁≤–10 dB) within 3.17-6.88 GHz and 15.84-18 GHz and a transmission bandwidth (S₁₁≤-10 dB and S₂₁≥-3 dB) within 8.64-10.15 GHz.

### Embodiment 4

A system for intelligently designing a frequency-selective metamaterial with integrated absorption-transmission to electromagnetic waves of this embodiment is the same as that of Embodiment 2, except that another frequency-selective metamaterial is designed through the user interface.

Referring to the user interface shown in FIG. 9d, a designed frequency-selective metamaterial with integrated absorption-transmission to electromagnetic waves has the symmetric structure composed of n × n unit structures arranged periodically. Each of the n × n unit structures includes the first frequency-selective metastructure layer, the dielectric layer and the second frequency-selective metastructure layer laminated in sequence from bottom to top. One unit structure of the first frequency-selective metastructure layer has a square-ring shape, having an outer-ring side length a₁ of 15.15 mm, an inner-side length a₂ of 9.19 mm, and a sheet resistance of 3 Ω/sq. One unit structure of the second frequency-selective metastructure layer has a cross shape, and has a unit size of a₁_{,} an arm length b₁of 14.72 mm, an arm width b₂of 1.23 mm, and a sheet resistance of 15 Ω/sq. One unit structure of the dielectric layer has a square shape, and has a side length of a₁ and a thickness h of 3.65 mm. The designed frequency-selective metamaterial realizes an absorption bandwidth (S₁₁≤–10 dB and S₂₁≤–10 dB) within 3.95-9.75 GHz and a transmission bandwidth (S₁₁≤-10 dB and S₂₁≥-3 dB) within 13.80-14.32 GHz.

Described above are specific embodiments of the present disclosure, which are intended to enable those of ordinary skill in the art to understand or implement the present disclosure, rather than limiting the disclosure. Although the disclosure has been described in detail with reference to the above embodiments, it should be understood that those of ordinary skill in the art can still make modifications and equivalent replacements to some or all of the technical features recited in the above embodiments. Such modifications and replacements made without departing from the scope of the present disclosure shall fall within the scope of this application defined by the appended claims.

What is claimed is:

1. A system for intelligently designing a frequency-selective metamaterial with integrated absorption-transmission to electromagnetic waves, comprising:
a first artificial neural network;
a second artificial neural network;
a third artificial neural network; and
a user interface;
wherein the first artificial neural network is a S-parameter neural network (SNN); the second artificial neural network is an inverse neural network (INN); and the third artificial neural network is a forward neural network (FNN);
the SNN is a fully connected neural network, comprising a first input layer, a first hidden layer, and a first output layer; the number of nodes in the first input layer Input(S) is 101-1601; the number of sub-layers of the first hidden layer Hide(S-D) is 1-10; the number of nodes in each sub-layer of the first hidden layer Hide(S-W) is 100-600; the number of nodes in the first output layer Output(S) is 101-1601; and the SNN is configured to input a target electromagnetic response parameter S₂₁ of a desired metamaterial, and predict and output a target electromagnetic response parameter S₁₁ of the desired metamaterial;
the INN is a fully connected neural network comprising an S₁₁ input sub-network, an S₂₁ input sub-network, and a structure parameter prediction sub-network;
the S₁₁ input sub-network comprises a second input layer, a second hidden layer, and a second output layer; the number of nodes in the second input layer Input(I-S₁₁) is 101-1601; the number of sub-layers of the second hidden layer Hide(I-S₁₁-D) is 1-5; the number of nodes in each sub-layer of the second hidden layer Hide(I-S₁₁-W) is 100-300; the number of nodes in the second output layer Output(I-S₁₁) is 101-1601; and the S₁₁ input sub-network is configured to process the target electromagnetic response parameter S₁₁;
the S₂₁ input sub-network comprises a third input layer, a third hidden layer, and a third output layer; the number of nodes in the third input layer Input(I-S₂₁) is 101-1601; the number of sub-layers of the third hidden layer Hide(I-S₂₁-D) is 1-5; the number of nodes in each sub-layer of the third hidden layer Hide(I-S₂₁-W) is 100-300; the number of nodes in the third output layer Output(I-S₂₁) is 101-1601; and the S₂₁ input sub-network is configured to process the target electromagnetic response parameter S₂₁;
the structure parameter prediction sub-network comprises a fourth input layer, a fourth hidden layer, and a fourth output layer; the number of nodes in the fourth input layer Input(I-P) is calculated by Input(I-P)=Output(I-S₁₁)+Output(I-S₂₁); the number of sub-layers of the fourth hidden layer Hide(I-P-D) is 1-5; the number of nodes in each sub-layer of the fourth hidden layer Hide(I-P-W) is 100-300; the number of nodes in the fourth output layer Output(I-P) is 5; and the structure parameter prediction sub-network is configured to predict a structure parameter conform to the target electromagnetic response parameter S₁₁ and the target electromagnetic response parameter S₂₁ based on data from the S₁₁ input sub-network and the S₂₁ input sub-network;
the FNN is a fully connected neural network comprising a structure parameter input sub-network, an S₁₁ prediction sub-network, and an S₂₁ prediction sub-network;
the structure parameter input sub-network comprises a fifth input layer, a fifth hidden layer, and a fifth output layer; the number of nodes in the fifth input layer Input(F-P) is 5; the number of sub-layers of the fifth hidden layer Hide(F-P-D) is 1-5; the number of nodes in each sub-layer of the fifth hidden layer Hide(F-P-W) is 100-400; the number of nodes in the fifth output layer Output(F-P) is 100-400; and the structure parameter input sub-network is configured to process the structure parameter predicted by the structure parameter prediction sub-network;
the S₁₁ prediction sub-network comprises a sixth input layer, a sixth hidden layer, and a sixth output layer; the number of nodes in the sixth input layer Input(F-S₁₁) is 50-350; the number of sub-layers of the sixth hidden layer Hide(F-S₁₁-D) is 1-5; the number of nodes in each sub-layer of the sixth hidden layer Hide(F-S₁₁-W) is 100-300; the number of nodes in the sixth output layer Output(F-S₁₁) is 101-1601; and the S₁₁ prediction sub-network is configured to predict an S₁₁ parameter conform to a structure parameter based on data from the structure parameter input sub-network;
the S₂₁ prediction sub-network comprises a seventh input layer, a seventh hidden layer, and a seventh output layer; the number of nodes in the seventh input layer Input(F-S₂₁) is calculated by Input(F-S₂₁)=Output(F-P)-Input(F-S₁₁); the number of sub-layers of the seventh hidden layer Hide(F-S₂₁-D) is 1-5; the number of nodes in each sub-layer of the seventh hidden layer Hide(F-S₂₁-W) is 100-300; the number of nodes in the seventh output layer Output(F-S₂₁) is 101-1601; and the S₂₁ prediction sub-network is configured to predict an S₂₁ parameter conform to the structure parameter based on the data from the structure parameter input sub-network; and
the user interface comprises 9 freely-draggable User-Points, an S₂₁ input curve generated by interpolation of the 9 freely-draggable User-Points, a structure parameter design result predicted by the INN, and a real-time adjustable and interactive graphical interface formed by an S₁₁ parameter curve and an S₂₁ parameter curve reconstructed by the FNN, a first reference line fixed at -3 dB and a second reference line fixed at -10 dB.

2. The system of claim 1, wherein the desired metamaterial has a symmetric structure composed of n × n unit structures arranged periodically, and n is a positive integer; each of the n × n unit structures comprises a first frequency-selective metastructure layer, a dielectric layer and a second frequency-selective metastructure layer laminated in sequence from bottom to top; and the second frequency-selective metastructure layer is a lossy frequency-selective metastructure layer; and
one unit structure of the first frequency-selective metastructure layer has a square-ring shape, having an outer-ring side length a₁ of 15.15-23.71 mm, an inner-ring side length a₂ of 9.04-14.33 mm, and a sheet resistance of 3-5 Ω/sq; one unit structure of the dielectric layer is square, and has a side length of a₁ and a thickness h of 3.12-9.16 mm; and one unit structure of the second frequency-selective metastructure layer has a cross shape, and has a unit size of a₁, an arm length b₁ of, an arm width b₂ of 1.23-3.25 mm, and a sheet resistance of 4-25 Ω/sq.
